(19) United States
(12) Patent Application Publication
(10) Pub. No.: US 2006/0219042 A1
(43) Pub. Date: Oct. 5, 2006

(54) Blade assembly for transmission of semiconductor chip

(76) Inventors: Wen-Chang Tu, Taichung (TW); Chu-Ching Kang, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/097,617

(22) Filed: Apr. 4, 2005

(51) Int. Cl. B25J 17/00

(52) U.S. Cl. 74/490.01

(57) ABSTRACT

A blade assembly is connected to a robot arm for transmission of semiconductor chips and includes a blade, a top cover, a bottom cover, and two pivot units each including a pivot arm, a first bearing, and a second bearing. Thus, the positioning flange of the mounting ring of the pivot arm is sandwiched between the first bearing and the second bearing and the inner washer is sandwiched between the inner ring of the first bearing and the inner ring of the second bearing, thereby preventing the first bearing from pressing and jamming the second bearing due to a pressing action of the urging cap, so that the pivot arm is pivotable smoothly and stably.

### BACKGROUND OF THE INVENTION

1. Field of the Invention

The present invention relates to a blade assembly, and more particularly to a blade assembly connected to a robot arm for transmission of semiconductor chips.

2. Description of the Related Art

A conventional blade assembly 50 in accordance with the prior art shown in FIGS. 5-8 comprises a blade 51 having an end portion formed with two guide grooves 511, a top cover 52 mounted on the blade 51 and having a first end formed with two guide pins 521 each inserted into a respective one of the two guide grooves 511 of the blade 51 so that the top cover 52 is secured on the blade 51 and a second end formed with two bearing seats 522, a bottom cover 53 mounted on the blade 51 and combined with the top cover 52, and two pivot units 54 each pivotally mounted between the top cover 52 and the bottom cover 53 and each including a pivot arm 543 pivotally mounted between the top cover 52 and the bottom cover 53 and having a first end formed with a mounting ring 545 rotatably mounted on a respective one of the two bearing seats 522 of the top cover 52 and a second end formed with a rocker handle 547 connected to and driven by a robot arm, a first bearing 541 mounted between the respective bearing seat 522 of the top cover 52 and the mounting ring 545 of the pivot arm 543, a second bearing 542 mounted on the mounting ring 545 of the pivot arm 543, and an urging cap 544 secured on the respective bearing seat 522 of the top cover 52 and rested on the second bearing 542 to attach each of the two pivot units 54 to the top cover 52. The mounting ring 545 of the pivot arm 543 of each of the two pivot units 54 has an inner wall formed with a positioning flange 546 rested on the first bearing 541 and the second bearing 452.

However, the positioning flange 546 of the mounting ring 545 of the pivot arm 543 is rested on the outer and inner rings of the first bearing 541 and the second bearing 542 respectively, so that the first bearing 541 and the second bearing 542 are pressed tightly after the urging cap 544 is locked on the respective bearing seat 522 of the top cover 52 to press the positioning flange 546 of the mounting ring 545 of the pivot arm 543, thereby affecting rotation of the pivot arm 543. In addition, each of the two guide pins 521 of the top cover 52 easily detaches from the respective guide groove 511 of the blade 51 so that the blade 51 easily slips from the top cover 52, thereby incurring vibration. Further, the blade 51 is made of aluminum alloy that cannot tolerate a higher temperature. Further, the blade 51 has a heavier weight, thereby increasing the load of the pivot arm 543 so that the pivot arm 543 is easily distorted or deformed due to fatigue. Further, the pivot arm 543 is made of aluminum alloy that has a smaller strength, so that the pivot arm 543 is easily deformed due to a larger force.

### SUMMARY OF THE INVENTION

In accordance with the present invention, there is provided a blade assembly, comprising: a blade; a top cover mounted on the blade; a bottom cover mounted on the blade and combined with the top cover; two pivot units each pivotally mounted between the top cover and the bottom cover and each including a pivot arm pivotally mounted between the top cover and the bottom cover and having an end formed with a mounting ring rotatably mounted on a respective one of the two bearing seats of the top cover, a first bearing mounted between the top cover and the mounting ring of the pivot arm, and a second bearing mounted on the mounting ring of the pivot arm; wherein the mounting ring of the pivot arm of each of the two pivot units has an inner wall formed with a positioning flange rested on and located between the first bearing and the second bearing.

The primary objective of the present invention is to provide a blade assembly connected to a robot arm for transmission of semiconductor chips.

Another objective of the present invention is to provide a blade assembly, wherein the positioning flange of the mounting ring of the pivot arm is sandwiched between the first bearing and the second bearing and the inner washer is sandwiched between the inner ring of the first bearing and the inner ring of the second bearing, thereby preventing the first bearing from pressing and jamming the second bearing due to a pressing action of the urging cap, so that the pivot arm is pivotable smoothly and stably.

A further objective of the present invention is to provide a blade assembly, wherein the top cover is formed with two positioning pins each positioned in a respective one of the two positioning holes of the blade, so that the top cover is secured on the blade rigidly and stably to prevent detachment of the blade.

A further objective of the present invention is to provide a blade assembly, wherein the blade is made of ceramic material having a relatively higher density, so that the blade has a smaller thickness and lighter weight, thereby greatly reducing the load of the pivot arm to prevent the pivot arm from being distorted or deformed due to fatigue.

A further objective of the present invention is to provide a blade assembly, wherein the pivot arm is made of a titanium alloy having a lighter weight and greater strength, so that the pivot arm has a greater support strength, thereby preventing the pivot arm from being deformed due to a larger force.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a blade assembly in accordance with the preferred embodiment of the present invention;

FIG. 2 is a bottom plan assembly view of the blade assembly as shown in FIG. 1;

FIG. 3 is a side plan cross-sectional assembly view of the blade assembly as shown in FIG. 1;

FIG. 4 is a partially plan cross-sectional assembly view of the blade assembly as shown in FIG. 1;

FIG. 5 is an exploded perspective view of a conventional blade assembly in accordance with the prior art;

FIG. 6 is a bottom plan assembly view of the conventional blade assembly as shown in FIG. 5;

FIG. 7 is a side plan cross-sectional assembly view of the conventional blade assembly as shown in FIG. 5;

FIG. 8 is a partially plan cross-sectional assembly view of the conventional blade assembly as shown in FIG. 5.

### DETAILED DESCRIPTION OF THE INVENTION

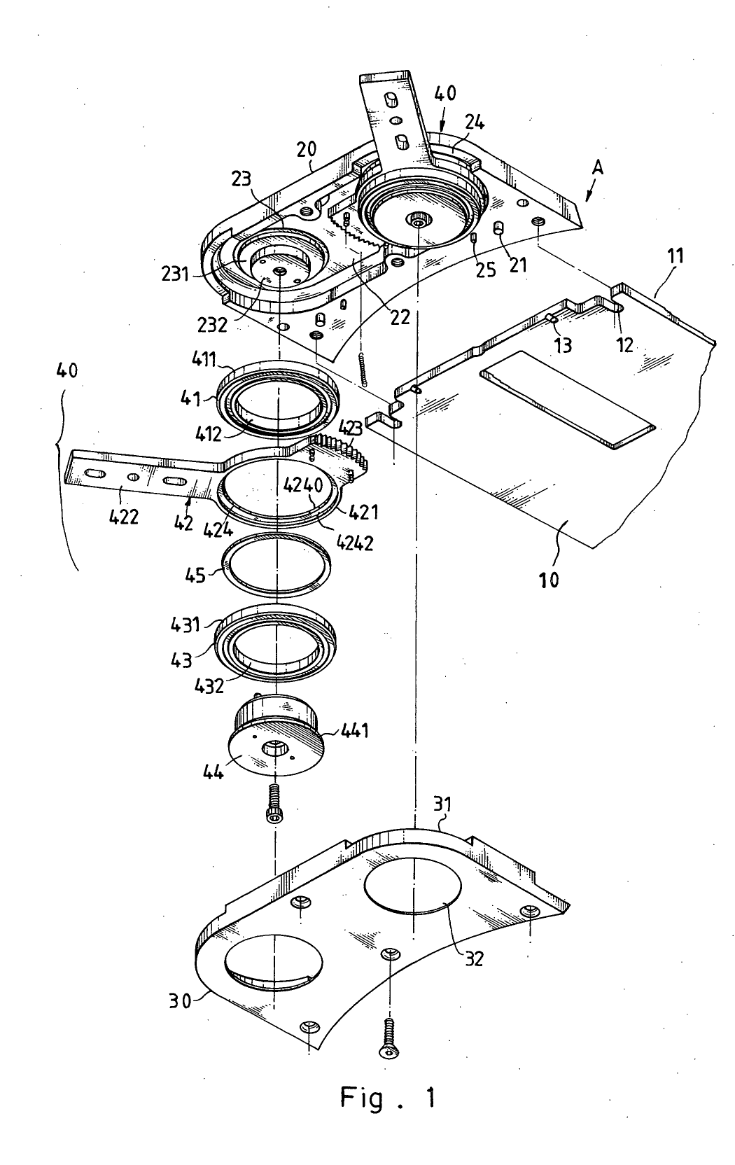

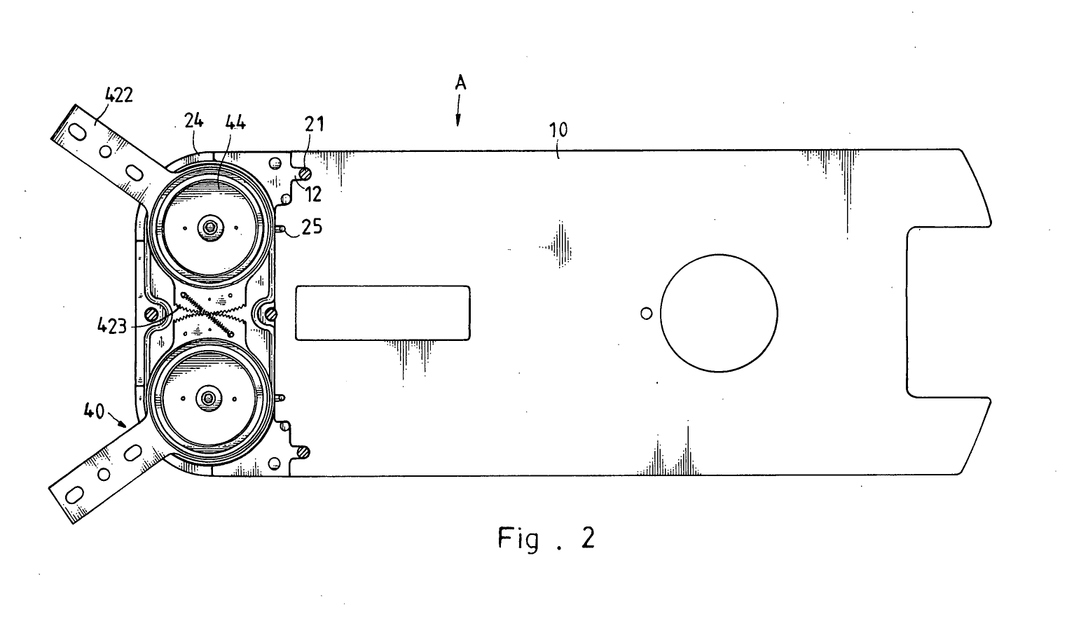

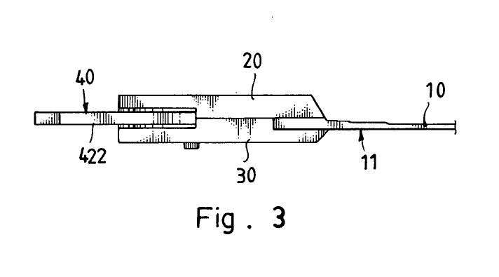

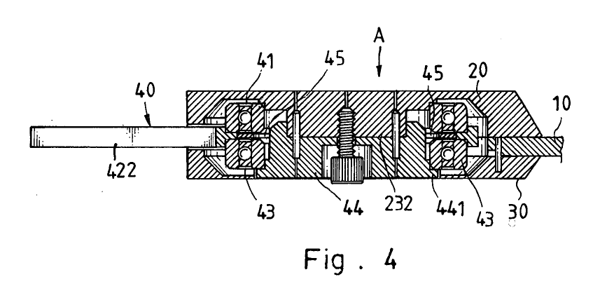

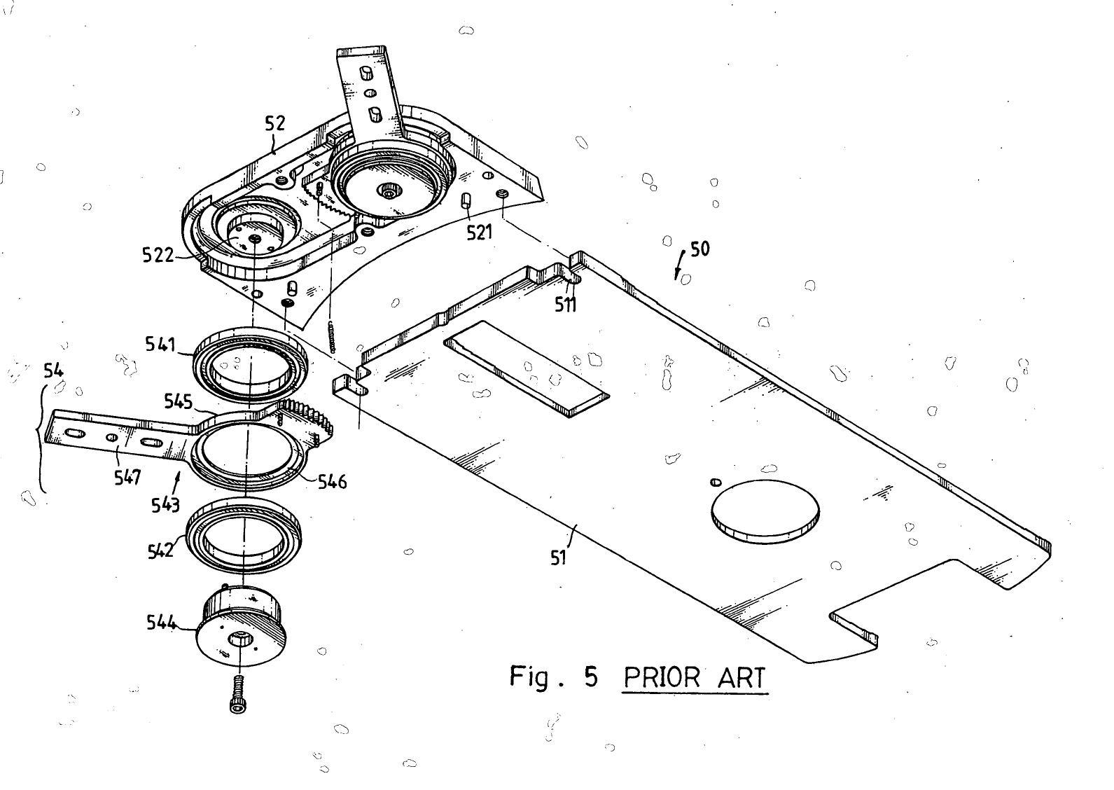

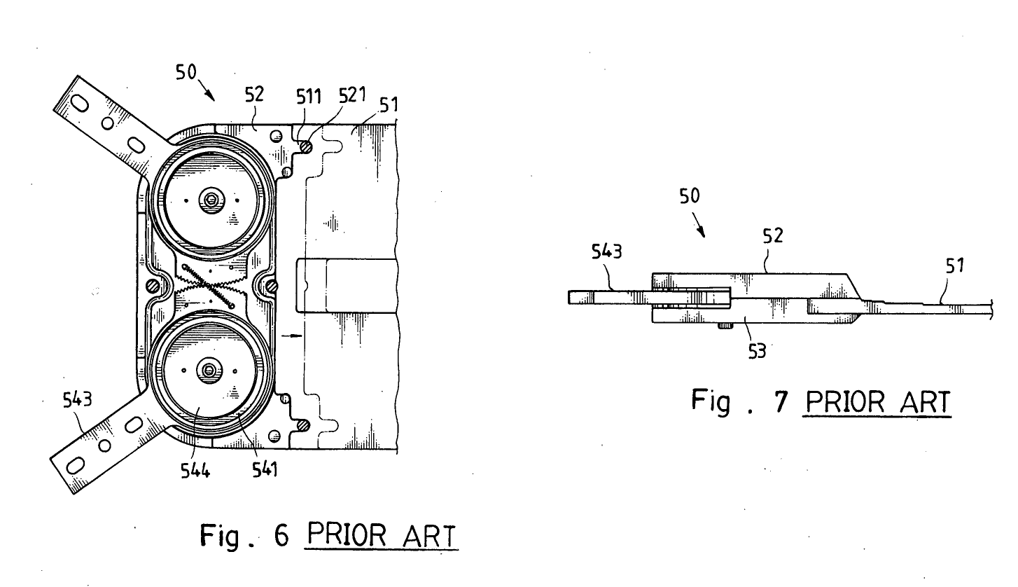

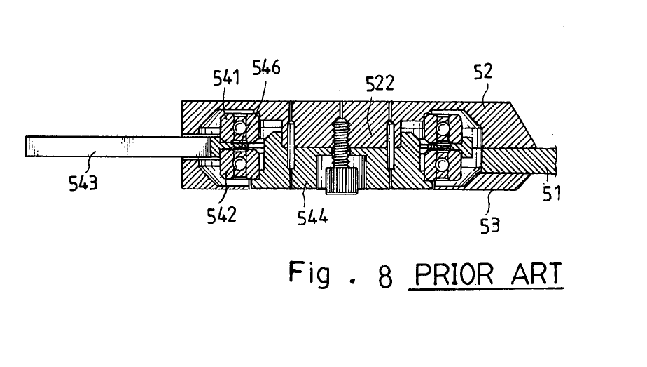

Referring to FIGS. 1-4, a blade assembly “A” in accordance with the present invention is connected to a robot arm for transmission and support of semiconductor chips. The blade assembly “A” comprises a blade 10, a top cover 20 mounted on the blade 10, a bottom cover 30 mounted on the blade 10 and combined with the top cover 20, and two pivot units 40 each pivotally mounted between the top cover 20 and the bottom cover 30.

The blade 10 has a support face 11 for supporting the semiconductor chips and has an end portion formed with two guide grooves 12.

The top cover 20 has a first end formed with two guide pins 21 each inserted into a respective one of the two guide grooves 12 of the blade 10 so that the top cover 20 is secured on the blade 10. The top cover 20 has a second end formed with a receiving recess 22 formed with two bearing seats 23 each having an annular groove 231 and a protruding locking portion 232 located in the annular groove 231.

Each of the two pivot units 40 includes a pivot arm 42 pivotally mounted between the top cover 20 and the bottom cover 30 and having a first end formed with a mounting ring 421 rotatably mounted on a respective one of the two bearing seats 23 of the top cover 20 and a second end formed with a rocker handle 422 protruded outward from the top cover 20 and the bottom cover 30 and connected to and driven by a robot arm, a first bearing 41 mounted between the annular groove 231 of the respective bearing seat 23 of the top cover 20 and the mounting ring 421 of the pivot arm 42, a second bearing 43 mounted on the mounting ring 421 of the pivot arm 42, and an urging cap 44 secured on the locking portion 232 of the respective bearing seat 23 of the top cover 20 and having a peripheral edge 441 rested on the second bearing 43 to attach each of the two pivot units 40 to the top cover 20. The mounting ring 421 of the pivot arm 42 of each of the two pivot units 40 has a periphery formed with a plurality of engaging teeth 423, wherein the engaging teeth 423 of the two pivot units 40 mesh with each other so that each of the two pivot units 40 are pivoted simultaneously.

The second end of the top cover 20 is formed with two openings 24 to allow pivot of each of the two pivot units 40, and the bottom cover 30 is formed with two openings 31 to allow pivot of each of the two pivot units 40. The bottom cover 30 is formed with two receiving holes 32 for receiving the urging cap 44 of each of the two pivot units 40 to facilitate tightness adjustment of the urging cap 44.

In the preferred embodiment of the present invention, the mounting ring 421 of the pivot arm 42 of each of the two pivot units 40 has an inner wall formed with a positioning flange 424 rested on and located between the first bearing 41 and the second bearing 43. The positioning flange 424 of the mounting ring 421 of the pivot arm 42 of each of the two pivot units 40 has an annular stepped shape and is extended radially inward. The positioning flange 424 of the mounting ring 421 of the pivot arm 42 of each of the two pivot units 40 is sandwiched between the first bearing 41 and the second bearing 43 and has a first face formed with a retaining groove 4240 to receive an outer ring 411 of the first bearing 41 and a second face formed with a retaining groove 4242 to receive an outer ring 431 of the second bearing 43. Each of the two pivot units 40 further includes an annular inner washer 45 mounted in the positioning flange 424 of the mounting ring 421 of the pivot arm 42 and rested on an inner ring 412 of the first bearing 41 and an inner ring 432 of the second bearing 43.

In such a manner, the inner washer 45 is sandwiched between the inner ring 412 of the first bearing 41 and the inner ring 432 of the second bearing 43, thereby preventing the inner ring 412 of the first bearing 41 and the inner ring 432 of the second bearing 43 being pressed closely by the urging cap 44 after the urging cap 44 is locked on the top cover 20 and pressed on the second bearing 43, so that the pivot arm 42 of each of the two pivot units 40 is pivotable between the top cover 20 and the bottom cover 30 smoothly and stably. In addition, the inner washer 45 separates the inner ring 412 of the first bearing 41 from the inner ring 432 of the second bearing 43, so that the inner ring 412 of the first bearing 41 and the inner ring 432 of the second bearing 43 are rotated independently. Further, the mounting ring 421 of the pivot arm 42 only contacts the outer ring 411 of the first bearing 41 and the outer ring 431 of the second bearing 43 without contacting the inner ring 412 of the first bearing 41 and the inner ring 432 of the second bearing 43 during rotation of the pivot arm 42, so that the pivot arm 42 of each of the two pivot units 40 is pivoted smoothly.

In the preferred embodiment of the present invention, the end portion of the blade 10 is formed with two positioning holes 13 each located adjacent to a respective one of the two guide grooves 12, and the first end of the top cover 20 is formed with two positioning pins 25 each located adjacent to a respective one of the two guide pins 21 and each positioned in a respective one of the two positioning holes 13 of the blade 10, so that the top cover 20 is secured on the blade 10 rigidly and stably to prevent detachment of the blade 10. In addition, the blade 10 is made of ceramic material having a relatively higher density, so that the blade 10 has a smaller thickness and lighter weight, thereby greatly reducing the load of the pivot arm 42 to prevent the pivot arm 42 from being distorted or deformed due to fatigue. Further, the blade 10 is made of ceramic material having a heat resistance feature, so that the blade 10 is not deformed easily, thereby assuring stability of transmission and support of the semiconductor chips. Further, the pivot arm 42 is made of a titanium alloy having a lighter weight and greater strength, so that the pivot arm 42 has a greater support strength, thereby preventing the pivot arm 42 from being deformed due to a larger force.

Accordingly, the positioning flange 424 of the mounting ring 421 of the pivot arm 42 is sandwiched between the first bearing 41 and the second bearing 43 and the inner washer 45 is sandwiched between the inner ring 412 of the first bearing 41 and the inner ring 432 of the second bearing 43, thereby preventing the first bearing 41 from pressing and jamming the second bearing 43 due to a pressing action of the urging cap 44, so that the pivot arm 42 is pivotable smoothly and stably. In addition, the top cover 20 is formed with two positioning pins 25 each positioned in a respective one of the two positioning holes 13 of the blade 10, so that the top cover 20 is secured on the blade 10 rigidly and stably to prevent detachment of the blade 10. Further, the blade 10 is made of ceramic material having a relatively higher density, so that the blade 10 has a smaller thickness and lighter weight, thereby greatly reducing the load of the pivot arm 42 to prevent the pivot arm 42 from being distorted or deformed due to fatigue. Further, the pivot arm 42 is made of a titanium alloy having a lighter weight and greater strength, so that the pivot arm 42 has a greater support strength, thereby preventing the pivot arm 42 from being deformed due to a larger force.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A blade assembly, comprising:
a blade;
a top cover mounted on the blade;
a bottom cover mounted on the blade and combined with the top cover;
two pivot units each pivotally mounted between the top cover and the bottom cover and each including a pivot arm pivotally mounted between the top cover and the bottom cover and having an end formed with a mounting ring rotatably mounted on a respective one of the two bearing seats of the top cover, a first bearing mounted between the top cover and the mounting ring of the pivot arm, and a second bearing mounted on the mounting ring of the pivot arm;
wherein the mounting ring of the pivot arm of each of the two pivot units has an inner wall formed with a positioning flange rested on and located between the first bearing and the second bearing.

2. The blade assembly in accordance with claim 1, wherein the positioning flange of the mounting ring of the pivot arm of each of the two pivot units has an annular stepped shape.

3. The blade assembly in accordance with claim 1, wherein the positioning flange of the mounting ring of the pivot arm of each of the two pivot units is extended radially inward.

4. The blade assembly in accordance with claim 1, wherein the positioning flange of the mounting ring of the pivot arm of each of the two pivot units has a first face formed with a retaining groove to receive an outer ring of the first bearing and a second face formed with a retaining groove to receive an outer ring of the second bearing.

5. The blade assembly in accordance with claim 1, wherein each of the two pivot units further includes an annular inner washer mounted in the positioning flange of the mounting ring of the pivot arm and rested on an inner ring of the first bearing and an inner ring of the second bearing.

6. The blade assembly in accordance with claim 5, wherein the positioning flange of the mounting ring of the pivot arm is sandwiched between the first bearing and the second bearing, and the inner washer is sandwiched between the inner ring of the first bearing and the inner ring of the second bearing, thereby preventing the first bearing from pressing and jamming the second bearing.

7. The blade assembly in accordance with claim 5, wherein the inner washer separates the inner ring of the first bearing from the inner ring of the second bearing, so that the inner ring of the first bearing and the inner ring of the second bearing are rotated independently.

8. The blade assembly in accordance with claim 5, wherein the mounting ring of the pivot arm contacts an outer ring of the first bearing and an outer ring of the second bearing without contacting the inner ring of the first bearing and the inner ring of the second bearing during rotation of the pivot arm.

9. The blade assembly in accordance with claim 1, wherein the blade has an end portion formed with two guide grooves and two positioning holes each located adjacent to a respective one of the two guide grooves, and the top cover has an end portion formed with two guide pins each inserted into a respective one of the two guide grooves of the blade and two positioning pins each located adjacent to a respective one of the two guide pins and each positioned in a respective one of the two positioning holes of the blade, so that the top cover is secured on the blade.

10. The blade assembly in accordance with claim 1, wherein the blade is made of ceramic material having a relatively higher density, so that the blade has a smaller thickness and lighter weight, thereby reducing a load of the pivot arm.

11. The blade assembly in accordance with claim 1, wherein the blade is made of ceramic material having a heat resistance feature.

12. The blade assembly in accordance with claim 1, wherein the pivot arm is made of a titanium alloy having a lighter weight and greater strength, so that the pivot arm has a greater support strength.
